(19) United States
(12) Patent Application Publication
(10) Pub. No.: US 2008/0155975 A1
(43) Pub. Date: Jul. 3, 2008

(54) Hydraulic system with energy recovery

(75) Inventor: Jason L. Brinkman, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/646,542

(22) Filed: Dec. 28, 2006

(51) Int. Cl. F15B 21/14; F16D 31/02; F15B 15/00; F15B 11/02; F15B 1/02

(52) U.S. Cl. 60/414; 60/477; 60/327

(57) ABSTRACT

A hydraulic system is disclosed. The hydraulic system includes an actuator including a first, a second, and a third fluid chamber. The hydraulic system also includes a high pressure source of pressurized fluid in selective fluid communication with the first and second fluid chambers. The hydraulic system also includes a low pressure source of pressurized fluid in selective fluid communication with the first and second fluid chambers. The hydraulic system further includes a hydraulic motor in fluid communication with the third fluid chamber.

### TECHNICAL FIELD

The present disclosure relates to hydraulic systems and, more particularly, to hydraulic systems with energy recovery.

### BACKGROUND

Hydraulic systems often include one or more actuators configured to affect movement of an operatively connected load. Often machines include one or more such hydraulic systems to affect movement of one or more components, such as, for example, a frame member, a linkage, an implement, and/or other components. The hydraulic system usually includes a pump configured to supply pressurized fluid and a valve arrangement configured to direct pressurized fluid to and from an actuator. The actuator is often a piston-cylinder arrangement where the valve arrangement selectively supplies pressurized fluid to a first chamber therein and selectively drains pressurized fluid from a second chamber therein to affect movement of the piston with respect to the cylinder. Often the pressurized fluid drained from the actuator is directed toward a tank, potentially wasting energy associated with the actuator and/or the pressurized fluid. For example, the actuator may have potential energy when in an extended position that may be wasted by merely draining pressurized fluid to the tank during a retracting movement, especially if the operatively connected load acts in a direction to assist the retracting movement.

U.S. patent application Publication No. 2005/0066655 (“the '655 application”) filed by Aarestad et al. discloses a cylinder with internal pushrod. The cylinder of the '655 application includes a piston rod assembly and a tubular element associated with first and second sources of pressurized fluid, e.g., a fluid pump and an accumulator, within a hydraulic circuit. The piston rod assembly and tubular element establish an axial passage therebetween and fluid disposed therein may be directed to the accumulator when the volume of the axial passage decreases, e.g., when the piston rod assembly retracts with respect to the cylinder. Pressurized fluid may be directed from the accumulator to other portions of the hydraulic circuit to assist in extending the piston rod assembly with respect to the cylinder to thereby reduce the flow and/or pressure of pressurized fluid directed from the pump to affect an extension of the piston rod assembly with respect to the cylinder.

Because the '655 application includes an accumulator to store energy associated with the pressurized fluid directed from the third chamber of the actuator, the affects thereof on the movement of the load may not be variable. Additionally, the '655 application may require a complex hydraulic circuit to recover and store energy associated with the third chamber and subsequently redirect pressurized fluid within the accumulator toward other portions of the hydraulic circuit.

The present disclosure is directed to overcoming one or more of the shortcomings set forth above.

### SUMMARY OF THE INVENTION

In one aspect, the present disclosure is directed to a hydraulic system. The hydraulic system includes an actuator including a first, a second, and a third fluid chamber. The hydraulic system also includes a high pressure source of pressurized fluid in selective fluid communication with the first and second fluid chambers. The hydraulic system also includes a low pressure source of pressurized fluid in selective fluid communication with the first and second fluid chambers. The hydraulic system further includes a hydraulic motor in fluid communication with the third fluid chamber.

In another aspect, the present disclosure is directed to a method of producing energy with a hydraulic actuator. The method includes selectively directing pressurized fluid from a first chamber of the hydraulic actuator toward a low pressure source to establish a retraction of the hydraulic actuator. The method also includes directing pressurized fluid from a second chamber of the hydraulic actuator toward a third chamber via a hydraulic motor during the retraction of the hydraulic actuator. The method further includes producing an output energy via the hydraulic motor.

### BRIEF DESCRIPTION OF THE DRAWINGS

FIG. 1 is a diagrammatic illustration of a exemplary hydraulic system in accordance with the present disclosure.

### DETAILED DESCRIPTION

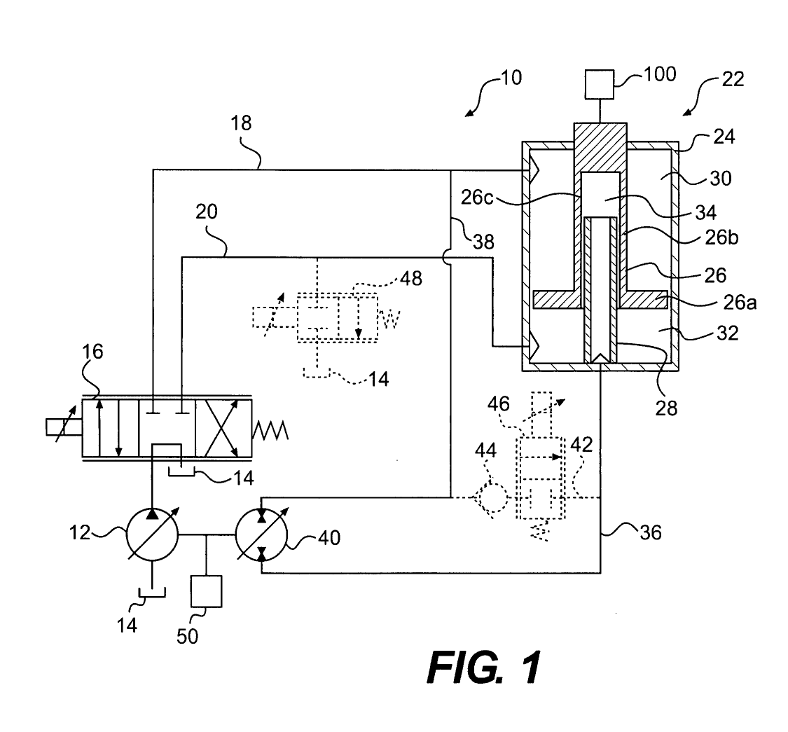

FIG. 1 illustrates an exemplary hydraulic system 10. Hydraulic system 10 may include a high pressure source 12, a low pressure source 14, a valve 16, an actuator 22, and a hydraulic motor 40. Hydraulic system 10 may also include one or more passageways fluidly interconnecting one or more components thereof. It is contemplated that hydraulic system 10 may include additional and/or different components such as, for example, pressure sensors, temperature sensors, position sensors, controllers, accumulators, relief valves, make-up valves, and/or other components known in the art.

High pressure source 12 may be configured to produce a flow of pressurized fluid and may include a pump such as, for example, a variable displacement pump, a fixed displacement pump, or any other source of pressurized fluid known in the art. High pressure source 12 may be drivably connected to a power source (not shown) by, for example, a countershaft (not shown), a belt (not shown), an electrical circuit (not shown), or in any other suitable manner. High pressure source 12 may be disposed between low pressure source 14 and valve 16. High pressure source 12 may be dedicated to supplying pressurized fluid only to hydraulic system 10 or, alternately, may supply pressurized fluid to one or more additional hydraulic systems (not shown).

Low pressure source 14 may include one or more tanks or reservoirs configured to hold a supply of fluid. The fluid may include, for example, a dedicated hydraulic oil, an engine lubrication oil, a transmission lubrication oil, or any other fluid known in the art. It is contemplated that low pressure source 14 may hold fluid for one or more additional hydraulic systems.

Valve 16 may be configured to selectively communicate pressurized fluid between high pressure source 12 and low pressure source 14 and actuator 22. Valve 16 may be disposed downstream of high pressure source 12 and upstream of rod-end and head-end passageways 18, 20. Valve 16 may include a three position solenoid actuated and spring biased valve having a first position in which fluid is substantially blocked from flowing to either rod-end passageway 18 or head-end passageway 20. Valve 16 may also include a second position in which high pressure source 12 may be fluidly communicated with rod-end passageway 18 and low pressure source 14 may be fluidly communicated with head-end passageway 20. Valve 16 may also include a third position in which high pressure source 12 may be fluidly communicated with head-end passageway 20 and low pressure source 14 may be fluidly communicated with rod-end passageway 18. It is contemplated that in the first position, valve 16 may be further configured to direct pressurized fluid from high pressure source 12 toward low pressure source 14. It is also contemplated that valve 16 may, alternatively, include any conventional valve arrangement known in the art, such as, for example a plurality of valves configured to independently and selectively communicate rod-end and head-end passageways 18, 20 with high and low pressure sources 12, 14.

Actuator 22 may include a cylinder 24, a piston 26, and a tube 28 and may be configured to affect movement of a load 100 operatively connected to piston 26 as a function of pressurized fluid selectively supplied to and drained from actuator 22 via valve 16. Piston 26 may include a plunger 26a defining a rod-end chamber 30 and a head-end chamber 32 within cylinder 24. Rod-end chamber may be fluidly connected to rod-end passageway 18 and head-end chamber 32 may be fluidly connected to head-end passageway 20. Piston 26 may also include a rod 26b operatively connected to plunger 26a, extending out of cylinder 24, and operatively connected to load 100. Piston 26 may also include a cavity 26c disposed within at least a portion of rod 26b. Tube 28 may include a tubular member having a hollow interior, a first end thereof connected to cylinder 24, and a second end thereof extending into cylinder 24 and into cavity 26c of piston 26. Tube 28 and cavity 26c may define a third chamber 34 within cylinder 24 that may be fluid connected to a recovery passageway 36. It is contemplated that a sealing members (not shown), such as, for example, a gasket or an o-ring, may be arranged between plunger 26a and an internal surface of cylinder 24 to substantially seal rod-end chamber 30 with respect to head-end chamber 32, and between an internal wall of cavity 26c and tube 28 to substantially seal head-end chamber 32 from third chamber 34. It is also contemplated that load 100 may include any type of load including, for example, a linkage configured to maneuver an implement of a machine, e.g., a blade, a ripper, a shovel, the implement itself, a frame of a machine, and/or any other load known in the art.

Actuator 22 may extend and retract as a function of selectively fluidly communicating high pressure source 12 with one of rod-end or head-end chambers 30, 32 and fluidly communicating low pressure source 14 with the other one of rod-end or head-end chambers 30, 32. As such, a pressure differential may be established across plunger 26a affecting rod 26b to extend or retract with respect to cylinder 24 as is known in the art. Movement of actuator 22, e.g., extension and/or retraction of rod 26b, may affect movement of load 100 which may assist or resist movement of actuator 22. For example, if load 100 acts in the retracting direction when rod 26b retracts, load 100 may assist actuator 22 in moving and a relatively lower force, applied to the rod-end chamber side of plunger 26a, may be sufficient to affect movement of actuator 22 than if load 100 acts in the extending direction. Load 100 may similarly assist movement of actuator 22 in the extending direction.

Hydraulic motor 40 may be disposed between recovery passageway 36 and a recycle passageway 38. Hydraulic motor 40 may be a variable displacement hydraulic motor configured to produce an energy output, e.g., a rotary torque and rotary speed, as a function of pressurized fluid supplied thereto. Hydraulic motor 40 may be drivably connected to high pressure source 12, a power source (not shown), and/or other energy consuming device by, for example, a countershaft (not shown), a belt (not shown), an electrical circuit (not shown), or in any other suitable manner to selectively supply power thereto. Additionally and/or alternatively, hydraulic motor 40 may be drivingly connected to an energy storage device 50, e.g., an alternator and battery or flywheel, configured to store energy for subsequent supply to high pressure source 12, the power source, and/or other energy consuming device. Hydraulic motor 40 may include one or more chambers therein configured to receive pressurized fluid and convert the potential energy of the pressurized fluid into kinetic energy. Hydraulic motor 40 may receive pressurized fluid from third chamber 34 via recovery passageway 36 and may deliver pressurized fluid toward rod-end chamber 30 via recycle passageway 38. It is contemplated that by varying the displacement of hydraulic motor 40 and, thus the amount of pressurized fluid directed therethrough, the energy produced by hydraulic motor may also be varied.

Hydraulic system 10 may, optionally, include a bypass passageway 42, a check valve 44, and a control valve 46. Bypass passageway 42 may be configured to connect recovery passageway 36 and recycle passageway 38 between actuator 22 and hydraulic motor 40. Check valve 44 may be disposed within bypass passageway 42 between recycle passageway 38 and control valve 46 which may be disposed within bypass passageway 42 between check valve 44 and recovery passageway 36. Check valve 44 may be configured to allow pressurized fluid to flow from recycle passageway 38 toward control valve 46 and substantially block pressurized fluid from flowing from control valve 46 toward recycle passageway 38. Control valve 46 may include a two position solenoid actuated and spring biased valve having a first position substantially blocking a flow of pressurized fluid and a second position allowing a flow of pressurized fluid. It is contemplated that check valve 44 may, alternatively, be disposed within control valve 46.

Hydraulic system 10 may also, optionally, include a drain valve 48 configured to selectively fluidly communicate head-end passageway 20 and, thus, head-end chamber 32, with low pressure source 14. Drain valve 48 may include a two position solenoid actuated and spring biased valve having a first position in which fluid is substantially blocked from flowing toward low pressure source 14 and having a second position in which fluid is allowed to flow toward low pressure source 14. It is contemplated that drain valve 48 may be positioned in the first position when valve 16 is positioned in the third position, e.g., fluidly connecting rod-end chamber 30 with low pressure source 14, and may be positioned in the second position when valve 16 is positioned in the second position, e.g., fluidly connecting head-end chamber 32 with low pressure source 14. It is also contemplated that valve 48 may selectively increase the collective flow area and, thus allowing a greater amount of pressurized fluid to flow from head-end chamber 32 toward low pressure source 14, as compared to the flow area provided by valve 16. It is further contemplated that drain valve 48 may include a variable flow valve to allow a variable flow of pressurized fluid toward low pressure source 14.

### INDUSTRIAL APPLICABILITY

The disclosed hydraulic system may be applicable to any system where energy recovery may be desired. Hydraulic system 10 may convert potential energy recovered from actuator 22 into mechanical kinetic energy to be supplied to one or more power consuming devices. The operation of hydraulic system 10 is explained below.

High pressure source 12 may draw fluid contained within low pressure source 14 and supply pressurized fluid to valve 16. Depending upon the position of valve 16, pressurized fluid supplied from high pressure source 12 may be returned to low pressure source 14, e.g., valve 16 in the first position, may be directed to rod-end chamber 30, e.g., valve 16 in the second position, or may be directed to head-end chamber 32, e.g., valve 16 in the third position. By selectively controlling valve 16 among the three positions, movement of actuator 22 may be affected.

By selectively positioning valve 16 in the second position, pressurized fluid from high pressure source 12 may be directed toward rod-end chamber 30 and pressurized fluid within head-end chamber 32 may be directed toward low pressure source 14. Thus, a pressure differential may be established across plunger 26a and rod 26b may be affected to retract with respect to cylinder 24. As rod 26b retracts, rod-end chamber 30 may increase in volume and third chamber 34 may decrease in volume. As pressurized fluid is supplied to rod-end chamber 30 and pressurized fluid is drained from head-end chamber 32, the rate at which rod 26b retracts with respect to cylinder 24 may be restricted by the rate at which pressurized fluid within head-end chamber 32 drains through valve 16. It is contemplated that such a restricted movement may or may not be desirable. For example, the restriction may beneficially slow the retraction of rod 26b when a controlled movement of load 100, acting in the retracting direction, may be desired. Conversely, the restriction may adversely slow the retraction of rod 26b when a controlled movement of load 100, acting in the retracting direction, may not desired.

Similarly, the flow of pressurized fluid drained from third chamber 34 may also influence the rate at which rod 26b retracts with respect to cylinder 24. As the volume of third chamber decreases, the pressurized fluid contained within third chamber 34 may be directed therefrom and directed toward hydraulic motor 40 via recovery passageway 36. Hydraulic motor 40 may receive the pressurized fluid from third chamber 34, produce an energy output, and direct pressurized fluid toward rod-end chamber 30 via recycle passageway 38. Additionally, by varying the displacement of hydraulic motor 40 and, thus the amount of pressurized fluid allowed to flow therethrough, the rate at which pressurized fluid contained within third chamber 34 may be correspondingly controlled which may have a similar restrictive affect on the retraction of rod 26b and load 100 as does valve 16. It is contemplated that during a retraction movement of actuator 22, the pressure of pressurized fluid upstream of hydraulic motor 40 may be higher than the pressure of pressurized fluid downstream of hydraulic motor 40 which may be a result of hydraulic motor converting the potential energy of the higher pressure fluid into mechanical energy.

Additionally and alternatively, valve 48 may be positioned in the second position and pressurized fluid within head-end chamber 32 may be directed toward low pressure source 14 via drain valve 48. Thus, an increased amount of pressurized fluid may be directed from head-end chamber 32 toward low pressure source 14 as compared with valve 16 potentially reducing the influence valve 16 may have on the retraction of rod 26b and load 100. It is contemplated that valve 48 may be positioned in the second position to reduce the restrictive affects of valve 16, thus, allowing hydraulic motor 40 and pressurized fluid directed thereto to have a greater influence on the rate at which rod 26b retracts with respect to cylinder 24.

By selectively positioning valve 16 in the third position, pressurized fluid from high pressure source 12 may be directed toward head-end chamber 32 and pressurized fluid within rod-end chamber 30 may be directed toward low pressure source 14. Thus, a pressure differential may be established across plunger 26a and rod 26b may be affected to extend with respect to cylinder 24. As rod 26b extends, head-end chamber 32 and third chamber 34 may both increase in volume. As such, pressurized fluid may be drawn into third chamber 34 from recovery passageway 36. Hydraulic motor 40 may receive pressurized fluid from rod-end chamber 30 via recycle passageway 38 and direct pressurized fluid to recovery passageway 36. It is contemplated that hydraulic motor 40 may be decoupled from the energy consuming device, e.g., high pressure source 12, via, for example, a one-way clutch apparatus or other decoupling device known in the art to reduce the restrictive affects hydraulic motor 40 may have on the flow of pressurized fluid from recycle passageway 38 toward third chamber 34.

Additionally and alternatively, pressurized fluid may be directed from recycle passageway 38 to recovery passageway 36 via bypass passageway 42. As rod 26b extends and third chamber 34 increases in volume, control valve 46 may be positioned in the second position, e.g., the flow passing position, and pressurized fluid within rod-end chamber 30 may be directed toward third chamber 34 via recycle passageway 38, check valve 44, control valve 46, and recovery passageway 36. As such, hydraulic motor 40 may be bypassed which may further reduce the resistive affects on fluid directed toward third chamber 34. It is contemplated that during an extension movement of actuator 22, the pressure of pressurized fluid downstream of hydraulic motor 40 and bypass passageway 42, may be lower than the pressure of pressurized fluid upstream of hydraulic actuator 40 and bypass passageway 42.

Because hydraulic motor 40 may be fluidly connected downstream of third chamber 34 when rod 26b retracts with respect to cylinder 24, potential energy associated with the pressurized fluid within third chamber 34 may be converted into kinetic energy and supplied to an energy consuming device. Additionally, by varying the displacement of hydraulic motor 40, movement of load 100 may be correspondingly varied. Furthermore, hydraulic system 10 may provide a relatively simple energy recovery system.

It will be apparent to those skilled in the art that various modifications and variations can be made to the disclosed hydraulic system. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A hydraulic system comprising:
an actuator including a first, a second, and a third fluid chamber;
a high pressure source of pressurized fluid in selective fluid communication with the first and second fluid chambers;
a low pressure source of pressurized fluid in selective fluid communication with the first and second fluid chambers; and
a hydraulic motor fluid communication with the third fluid chamber.

2. The hydraulic system of claim 1, wherein the hydraulic motor is also in fluid communication with the first chamber.

3. The hydraulic system of claim 1, wherein the hydraulic motor is configured to produce an energy output as a function of pressurized fluid selectively supplied thereto from the third chamber.

4. The hydraulic system of claim 1, wherein the third chamber is configured to decrease in volume when the first chamber increases in volume.

5. The hydraulic system of claim 1, wherein:
the actuator includes a piston configured to extend and retract with respect to a cylinder; and
the hydraulic motor is a variable displacement hydraulic motor configured to influence the rate at which the piston retracts with respect to the cylinder as a function of the variable displacement.

6. The hydraulic system of claim 5, further including:
a valve in fluid communication with the second chamber and configured to selectively permit pressurized fluid within the second chamber to flow toward the low pressure source.

7. The hydraulic system of claim 5, further including:
a valve in fluid communication with the first and third chambers and configured to selectively permit pressurized fluid within the first chamber to flow toward the third chamber.

8. A method of recovering energy associated a hydraulic actuator comprising:
selectively directing pressurized fluid from a first chamber of the hydraulic actuator toward a low pressure source to establish a retraction of the hydraulic actuator;
directing pressurized fluid from a second chamber of the hydraulic actuator toward a third chamber via a hydraulic motor during the retraction of the hydraulic actuator; and
producing an output energy via the hydraulic motor.

9. The method of claim 8, wherein:
the hydraulic motor is a variable displacement hydraulic motor and the retraction of the hydraulic actuator is influenced by the amount of pressurized fluid permitted to flow through the hydraulic motor.

10. The method of claim 8, wherein selectively directing pressurized fluid from the first chamber includes:
selectively opening a first valve having a first flow area; and
selectively opening a second valve having a second flow area.

11. The method of claim 8, further including:
selectively directing pressurized fluid from a high pressure source toward the first chamber to establish an extension of the hydraulic actuator; and
directing pressurized fluid from the third chamber toward the second chamber during an extension of the hydraulic actuator.

12. The method of claim 8, further including directing the pressurized fluid from the third chamber toward the second chamber via the hydraulic motor.

13. The method of claim 8, further including directing the pressurized fluid from the third chamber toward the second chamber via a valve and bypassing the hydraulic motor.

14. A hydraulic system comprising:
a high pressure source of pressurized fluid;
a low pressure source of pressurized fluid;
a hydraulic actuator including a first, second, and third fluid chambers therein;
a first valve fluidly connected with the first fluid chamber, the second fluid chamber, the high pressure source, and the low pressure source; and
a hydraulic motor fluidly connected with the first and third fluid chambers.

15. The hydraulic system of claim 14, further including a second valve fluidly connected with the second chamber and the low pressure source.

16. The hydraulic system of claim 14, further including a second valve fluidly connected with the first and third chambers and disposed between the hydraulic actuator and the hydraulic motor.

17. The hydraulic system of claim 14, wherein pressurized fluid within the third fluid chamber is directed toward the hydraulic motor when pressurized fluid within the second fluid chamber is directed toward the low pressure source.

18. The hydraulic system of claim 17, wherein the pressurized fluid directed toward the hydraulic motor is subsequently directed toward the first fluid chamber.

19. The hydraulic system of claim 14, wherein the hydraulic motor is configured to produce an output energy as a function of pressurized fluid selectively directed toward the hydraulic motor from the third fluid chamber.

20. The hydraulic system of claim 14, wherein:
the hydraulic actuator is configured to support a load;
the hydraulic motor is a variable displacement hydraulic motor; and
the rate at which the hydraulic actuator and the load move when pressurized fluid is directed toward the hydraulic motor from the third fluid chamber is a function of the displacement of the hydraulic motor.
